(19) United States
(12) Patent Application Publication
(10) Pub. No.: US 2023/0080938 A1
(43) Pub. Date: Mar. 16, 2023

(54) APPLICATION CONTROL METHOD AND APPARATUS, DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Lizhuo CHEN, Shenzhen (CN)

(73) Assignee: TENCENT TECHNOLOGY (SHENZHEN) COMPANY LIMITED, Shenzhen (CN)

(21) Appl. No.: 17/990,161

(22) Filed: Nov. 18, 2022

Related U.S. Application Data
(63) Continuation of application No. PCT/CN2022/083387, filed on Mar. 28, 2022.

(30) Foreign Application Priority Data
May 19, 2021 (CN) 202110546629.6

(51) Int. Cl. G06F 9/50; G06T 11/00; A63F 13/60

(52) U.S. Cl. CPC G06F 9/5033; G06T 11/00; A63F 13/60; G06T 2200/24; G06T 2210/62

(57) ABSTRACT

An application control method includes: acquiring a multimedia resource, the multimedia resource being based on historical data of an account that is logged into a second application, the account being the same as an account that is logged into a first application; and acquiring an operation instruction for the first application, executing the operation instruction in the first application, and displaying the multimedia resource.

### CROSS REFERENCE TO RELATED APPLICATIONS

This application is a continuation of International Application No. PCT/CN2022/083387 filed on Mar. 28, 2022 and claims priority to Chinese Patent Application No. 202110546629.6, filed with the China National Intellectual Property Administration on May 19, 2021, the contents of each of which being incorporated by reference herein in their entireties.

### FIELD

The disclosure relates to the technical field of the Internet, and in particular, to an application control method and apparatus, a device, and a computer-readable storage medium.

### BACKGROUND

With the continuous development of Internet technology, more and more types of applications have emerged, and different types of applications are enjoyed by more and more users. Users may control applications installed in electronic devices.

In the related art, an operation control such as a like control and a favorite control is displayed on a display interface of an application. When a user performs an operation (such as like or favorite) on content displayed by the application, the user clicks the corresponding operation control. An electronic device, in response to the click operation of the user on the operation control, changes the state of the operation control to a selected state, such as reddening the like control, thereby completing a control operation on the application.

However, the above-mentioned control mode for applications is relatively single and low in flexibility, so that the interaction between users and electronic devices is low, the user retention rate of applications is reduced, and thus the user attrition rate of applications is high.

### SUMMARY

According to an aspect of one or more embodiments, an application control method is provided. The method includes acquiring a multimedia resource, the multimedia resource being based on historical data of an account that is logged into a second application, the account being the same as an account that is logged into a first application; and acquiring an operation instruction for the first application, executing the operation instruction in the first application, and displaying the multimedia resource.

According to additional aspects of one or more embodiments, there is also provided an apparatus and non-transitory computer readable medium consistent with the method.

### BRIEF DESCRIPTION OF THE DRAWINGS

To describe the technical solutions of example embodiments of the disclosure more clearly, the following briefly describes the accompanying drawings required for describing the example embodiments of the disclosure. The accompanying drawings in the following description show only some embodiments of the disclosure, and a person of ordinary skill in the art may still derive other drawings from these accompanying drawings without creative efforts. In addition, one of ordinary skill would understand that aspects of example embodiments may be combined together or implemented alone.

FIG. 1 is a schematic diagram of an implementation environment of an application control method according to an example embodiment the disclosure.

FIG. 2 is a flowchart of an application control method according to an example embodiment the disclosure.

FIG. 3 is a schematic diagram of a display process of a multimedia resource according to an example embodiment the disclosure.

FIG. 4 is a flowchart of an application control method according to an example embodiment the disclosure.

FIG. 5 is a schematic architectural diagram of an application control method according to an example embodiment the disclosure.

FIG. 6 is a schematic structural diagram of an application control apparatus according to an example embodiment the disclosure.

FIG. 7 is a schematic structural diagram of an electronic device according to an example embodiment the disclosure.

FIG. 8 is a schematic structural diagram of a server according to an example embodiment the disclosure.

### DESCRIPTION OF EMBODIMENTS

Exemplary embodiments are described in detail herein, and examples thereof are shown in the accompanying drawings. When the following descriptions are made with reference to the accompanying drawings, unless otherwise indicated, the same numbers in different accompanying drawings represent the same or similar elements. The following implementations described in the following exemplary embodiments do not represent all implementations that are consistent with the disclosure. On the contrary, the implementations are merely examples of apparatuses and methods that are described in detail in the appended claims and consistent with some example embodiments of the disclosure.

To make objectives, technical solutions, and advantages of the disclosure clearer, implementations of the disclosure are further described below in detail with reference to the accompanying drawings.

In one aspect, some embodiments of the disclosure provide an application control method, including acquiring a multimedia resource that is determined based on historical data of an account logged in a second application, the account logged in the second application being the same as an account logged in a first application; and acquiring an operation instruction for the first application, executing the operation instruction in the first application, and displaying the multimedia resource.

In another aspect, some embodiments of the disclosure provide an application control apparatus, including an acquisition processor, configured to acquire a multimedia resource that is determined based on historical data of an account logged in a second application, the account logged in the second application being the same as an account logged in a first application; and a display processor, configured to acquire an operation instruction for the first application, execute the operation instruction in the first application, and display the multimedia resource.

According to another aspect, some embodiments of the disclosure provide an electronic device, including a processor and a memory, the memory storing at least one computer program, the at least one computer program being loaded and executed by the processor to cause the electronic device to implement the application control method according to any one of the foregoing aspects.

According to another aspect, a non-transitory computer-readable storage medium is further provided, storing at least one computer program, the at least one computer program being loaded and executed by a processor to cause a computer to implement the application control method according to any one of the foregoing aspects.

According to another aspect, a computer program or a computer program product is further provided, the computer program or the computer program product storing at least one piece of computer instruction, the at least one piece of computer instruction being loaded and executed by a processor to cause a computer to implement the application control method according to any one of the foregoing aspects.

According to the technical solution provided by the embodiments of the disclosure, after an operation instruction for a first application is acquired, not only the operation instruction is executed in the first application, but also a multimedia resource is additionally displayed. The multimedia resource is determined based on historical data of the same account logged in a second application. In this way, control modes for the first application are diversified and more flexible, the interaction between users and electronic devices is improved, users have better experience, the retention rate of users may be improved, and the user attrition rate of the first application may be reduced.

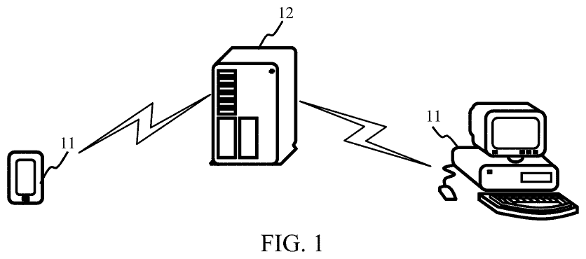

Referring to FIG. 1, a schematic diagram of an implementation environment of an application control method according to some embodiments of the disclosure is shown. The implementation environment includes: an electronic device 11 and a server 12.

The electronic device 11 may be a smartphone, a tablet computer, a notebook computer, a desktop computer, a smart speaker, a smartwatch, or the like, but is not limited thereto. The server 12 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The electronic device 11 and the server 12 may be directly or indirectly connected in a wired or wireless communication manner. This is not limited in the disclosure.

A person skilled in the art is to understand that the electronic device 11 and server 12 are only examples, and other existing or potential electronic devices or servers that are applicable to the disclosure are also to be included in the scope of protection of the disclosure, and are included herein by reference.

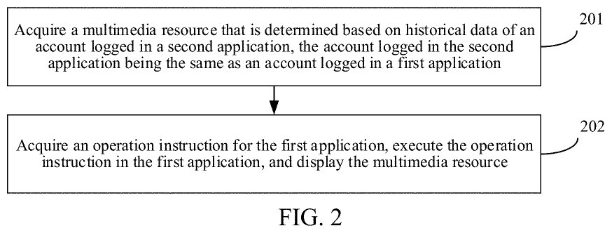

Based on the above-mentioned implementation environment, embodiments of the disclosure provide an application control method. The method may be performed by an electronic device 11 in FIG. 1 by taking a flowchart of an application control method according to some embodiments of the disclosure shown in FIG. 2 as an example. As shown in FIG. 2, the method includes the following operations 201 and 202:

In operation 201, a multimedia resource is acquired. The multimedia resource is determined based on historical data of an account logged in a second application. The account logged in the second application is the same as an account logged in a first application.

In some embodiments of the disclosure, a first application and a second application are installed in the electronic device. The first application may be any one of a short video type application, a social application type application, an information management type application, and a life encyclopedia type application, and the second application may be any one of a game type application and a video playing type application. The first application and the second application may also, certainly, be other types of applications. This is not limited in the embodiments of the disclosure.

In some embodiments, the timing for the electronic device to acquire the multimedia resource may be any timing after receiving a first operation on the first application. This is not limited by the embodiments of the disclosure. Exemplarily, the first operation on the first application is an operation for instructing to open the first application. However, the first operation on the first application may also be other operations. This is not limited by the embodiments of the disclosure.

In some embodiments, the process of acquiring a multimedia resource includes the following operations 1 to 3.

Operation 1: Acquire historical data of a second application. The historical data of the second application includes virtual objects acquired by an account logged in the second application and object information of the virtual objects.

In some embodiments, historical data corresponding to different accounts logged in a second application is stored in the electronic device, and the electronic device determines, based on an account logged in a first application, historical data of the account logged in the first application in the second application among the historical data corresponding to different accounts. The historical data includes a virtual object acquired by the account and object information of the virtual object.

In some embodiments, the object information of the virtual object includes at least one of an object type of the virtual object, a usage condition of the virtual object, an acquisition duration of the virtual object, a frequency at which an optimal account is acquired using the virtual object, a frequency at which a virtual resource is acquired for the virtual object, and a frequency at which an account level changes using the virtual object. The type of content in the above-mentioned contents included in the object information of the virtual object may be set empirically, or adjusted flexibly according to the type of the second application. This is not limited by the embodiments of the disclosure.

Exemplarily, when the second application is a game type application, the object information of the virtual object may include an object type of the virtual object, a usage condition of the virtual object, an acquisition duration of the virtual object, a frequency at which an optimal account is acquired using the virtual object, a frequency at which a virtual resource is acquired for the virtual object, and a frequency at which an account level changes using the virtual object. The object type of the virtual object is a hero type. The usage condition of the virtual object includes a frequency at which a game is played using the virtual object and a frequency at which the game wins. The acquisition duration of the virtual object includes a total duration of the game being played using the virtual object. The frequency at which an optimal account is acquired using the virtual object includes a frequency at which the game is played using the virtual object and a most valuable player (MVP) is acquired. The frequency at which a virtual resource is acquired for the virtual object is a frequency at which skin or props are purchased for the virtual object. The frequency at which an account level changes using the virtual object is a frequency at which the account level is increased after playing the game using the virtual object.

Exemplarily, when the second application is a video playing type application, the object information of the virtual object may include an object type of the virtual object, an acquisition duration of the virtual object, a frequency at which a virtual resource is acquired for the virtual object, and a frequency at which an account level changes using the virtual object. The object type of the virtual object is a video type. The acquisition duration of the virtual object is a total duration of video viewing. The frequency at which a virtual resource is acquired for the virtual object includes a frequency at which gifts are given for video. The frequency at which an account level changes using the virtual object includes a frequency at which an account viewing level is increased after viewing the video.

Operation 2: Determine, in response to the number of virtual objects acquired by the account being not less than a target number, a target object matching the account from the virtual objects acquired by the account based on the object information of the virtual objects acquired by the account.

In some embodiments, after acquiring virtual objects acquired by the account and object information of the virtual objects, it is determined whether the number of virtual objects acquired by the account is less than a target number. The process of determining, in response to the number of virtual objects acquired by the account being not less than a target number, a target object matching the account from the virtual objects acquired by the account based on the object information of the virtual objects acquired by the account is: determining between the virtual objects and the account based on the object information of the virtual objects acquired by the account; and determining a virtual object with the highest matching degree among the virtual objects acquired by the account as the target object.

In some embodiments, in response to the number of virtual objects acquired by the account being less than the target number, virtual resource acquisition frequencies of a plurality of virtual objects included in the second application are acquired, and a virtual object with the maximum virtual resource acquisition frequency among the plurality of virtual objects is determined as the target object. The plurality of virtual objects included in the second application are set empirically, or adjusted flexibly according to an application scenario. This is not limited by the embodiments of the disclosure. Exemplarily, the virtual resource acquisition frequency of any virtual object included in the second application refers to a frequency of any virtual object included in the second application acquiring a virtual resource.

The target number is set by a developer (e.g. a developer of a first application, or a developer of a second application, etc.), and may also be adjusted according to an application scenario. This is not limited in the embodiments of the disclosure.

Exemplarily, the virtual object is, for example, a hero. It is assumed that the target number is 3 and the number of heroes acquired by the account is 2. Since the number of heroes acquired by the account is less than the target number, virtual resource acquisition frequencies of a plurality of heroes included in the second application are acquired, and a hero with the maximum virtual resource acquisition frequency among the plurality of heroes is determined as the target object.

In some embodiments, the process of determining matching degrees between the virtual objects acquired by the account and the account based on the object information of the virtual objects acquired by the account is: determining a weight parameter corresponding to the object information based on the object information of the virtual objects acquired by the account; and determining matching degrees between the virtual objects acquired by the account and the account based on the object information of the virtual objects acquired by the account and the weight parameter corresponding to the object information.

In some embodiments, the determining a weight parameter corresponding to the object information based on the object information of the virtual objects acquired by the account includes at least one of the following: determining a type weight parameter of the virtual object based on an object type of the virtual object acquired by the account; determining a win weight parameter of the virtual object based on a usage condition of the virtual object acquired by the account; determining a duration weight parameter of the virtual object based on an acquisition duration of the virtual object acquired by the account; determining an account weight parameter of the virtual object based on a frequency at which an optimal account is acquired using the virtual object; determining a resource weight parameter of the virtual object based on a frequency at which a virtual resource is acquired for the virtual object; and determining a level weight parameter of the virtual object based on a frequency at which an account level changes using the virtual object.

In some embodiments, the process of determining a type weight parameter of the virtual object based on an object type of the virtual object acquired by the account is: storing corresponding relationships between object types and type weight parameters of virtual objects corresponding to different types of second applications in the electronic device. The electronic device determines a type weight parameter of the virtual object acquired by the account based on the object type of the virtual object acquired by the account and the corresponding relationships between object types and type weight parameters of virtual objects.

The following Table 1 shows a table indicating a corresponding relationship between an object type and a type weight parameter of a virtual object corresponding to a game type application according to some embodiments of the disclosure.

TABLE 1

| Object type of virtual object | Type weight parameter |
|---|---|
| Intelligence-type object | 0.5 |
| Strength-type object | 0.3 |
| Support-type object | 0.2 |

As shown in the above-mentioned Table 1, in response to the second application being a game type application, when the object type of the virtual object is an intelligence-type object, the type weight parameter of the virtual object is 0.5. When the object type of the virtual object is a strength-type object, the type weight parameter of the virtual object is 0.3. When the object type of the virtual object is a support-type object, the type weight parameter of the virtual object is 0.2.

The object type and the type weight parameter of the virtual object in the above-mentioned Table 1 are merely illustrative of some embodiments of the disclosure, and are not intended to limit type weight parameters corresponding to object types of various virtual objects. The object types of the three virtual objects shown in the above-mentioned Table 1 are also merely illustrative of the disclosure and are not intended to limit the number of object types of virtual objects included in the game type application.

Corresponding relationships between object types and type weight parameters of virtual objects corresponding to non-game type applications are also stored in the electronic device.

Exemplarily, the object type of the virtual object acquired by the account is an intelligence-type object, it is determined that the type weight parameter of the virtual object acquired by the account is 0.5 based on the object type of the virtual object acquired by the account and the corresponding relationships between object types and type weight parameters of virtual objects shown in the above-mentioned Table 1.

In some embodiments, the process of determining a win weight parameter of the virtual object based on a usage condition of the virtual object acquired by the account is: determining a win probability of the virtual object based on a usage condition of the virtual object acquired by the account; and determining a win weight parameter of the virtual object based on the win probability of the virtual object.

The usage condition of the virtual object includes a frequency at which the game is played using the virtual object and a frequency at which the game wins, and a quotient of the frequency at which the game wins and the frequency at which the game is played using the virtual object is determined as a win probability of the virtual object.

In some embodiments, corresponding relationships between win probabilities and win weight parameters of virtual objects corresponding to different types of second applications are stored in the electronic device. The following Table 2 shows a table indicating a corresponding relationship between a win probability and a win weight parameter of a virtual object corresponding to a game type application according to some embodiments of the disclosure.

TABLE 2

| Win probability of virtual object | Win weight parameter |
|---|---|
| [0, 0.3) | 0.3 |
| [0.3, 0.6) | 0.6 |
| [0.6, 0.8) | 0.8 |
| [0.8, 1.0] | 1.0 |

As shown in the above-mentioned Table 2, in response to the second application being a game type application, when the win probability of the virtual object is within an interval range [0, 0.3), the win weight parameter of the virtual object is 0.3. When the win probability of the virtual object is within an interval range [0.3, 0.6), the win weight parameter of the virtual object is 0.6. When the win probability of the virtual object is within an interval range [0.6, 0.8), the win weight parameter of the virtual object is 0.8. When the win probability of the virtual object is within an interval range [0.8, 1.0], the win weight parameter of the virtual object is 1.0.

The win weight parameter corresponding to the virtual object has a positive correlation with the win probability of the virtual object. That is to say, as the win probability of the virtual object is higher, the win weight parameter corresponding to the virtual object is higher. Conversely, as the win probability of the virtual object is lower, the win weight parameter corresponding to the virtual object is lower. When the win probability of the virtual object is within different interval ranges, the win weight parameter corresponding to the virtual object is merely as shown in the above-mentioned Table 2, and is not intended to limit the value of the win weight parameter corresponding to the virtual object.

Corresponding relationships between win probabilities and win weight parameters of virtual objects corresponding to non-game type applications are also stored in the electronic device.

Exemplarily, a frequency at which the game is played using the virtual object is 8, a frequency at which the game wins is 3, it is determined that the win probability of the virtual object is 0.375, and it is determined that the win weight parameter of the virtual object is 0.6 based on the win probability of the virtual object and the corresponding relationships between win probabilities and win weight parameters of virtual objects shown in the above-mentioned Table 2.

In some embodiments, the process of determining a duration weight parameter of the virtual object based on an acquisition duration of the virtual object acquired by the account is: storing corresponding relationships between acquisition durations and duration weight parameters of virtual objects corresponding to different types of second applications in the electronic device. The electronic device determines a duration weight parameter of the virtual object based on the acquisition duration of the virtual object acquired by the account and the corresponding relationships between acquisition durations and duration weight parameters of virtual objects.

The following Table 3 shows a table indicating a corresponding relationship between an acquisition duration and a duration weight parameter of a virtual object corresponding to a game type application according to some embodiments of the disclosure.

TABLE 3

| Acquisition duration of virtual | |
|---|---|
| object (processor: min) | Duration weight parameter |
| (0, 10) | 0.1 |
| [10, 50) | 0.5 |
| [50, 80) | 0.8 |
| [80, +∞) | 1.0 |

As shown in the above-mentioned Table 3, in response to the second application being a game type application, when the acquisition duration of the virtual object is within an interval range (0, 10), the duration weight parameter of the virtual object is 0.1. When the acquisition duration of the virtual object is within an interval range [10, 50), the duration weight parameter of the virtual object is 0.5. When the acquisition duration of the virtual object is within an interval range [50, 80), the duration weight parameter of the virtual object is 0.8. When the acquisition duration of the virtual object is within an interval range [80, +00), the duration weight parameter of the virtual object is 1.0.

The acquisition weight parameter corresponding to the virtual object has a positive correlation with the acquisition duration of the virtual object. That is to say, as the acquisition duration of the virtual object is longer, the duration weight parameter corresponding to the virtual object is higher. Conversely, as the acquisition duration of the virtual object is shorter, the duration weight parameter corresponding to the virtual object is lower. When the acquisition duration of the virtual object is within different interval ranges, the duration weight parameter corresponding to the virtual object is merely as shown in the above-mentioned Table 3, and is not intended to limit the value of the duration weight parameter corresponding to the virtual object.

Corresponding relationships between acquisition durations and duration weight parameters of virtual objects corresponding to non-game type applications are also stored in the electronic device.

Exemplarily, the acquisition duration of the virtual object acquired by the account is 30 min, it is determined that the duration weight parameter of the virtual object is 0.5 based on the acquisition duration of the virtual object and the corresponding relationships between acquisition durations and duration weight parameters of virtual objects shown in the above-mentioned Table 3.

In some embodiments, there may be two manners of determining an account weight parameter of the virtual object based on a frequency at which an optimal account is acquired using the virtual object.

In the first manner, a weight parameter of acquiring an optimal account using the virtual object each time is consistent, and a product of the weight parameter of acquiring an optimal account using the virtual object and a frequency at which an optimal account is acquired using the virtual object is determined as an account weight parameter of the virtual object.

Exemplarily, the weight parameter of acquiring an optimal account using the virtual object each time is 0.1, the frequency at which an optimal account is acquired using the virtual object is 10, the weight parameter of acquiring an optimal account using the virtual object each time is multiplied by the frequency at which an optimal account is acquired using the virtual object to obtain 0.1*10=1, and 1 is taken as an account weight parameter of the virtual object.

In the second manner, a weight parameter of acquiring an optimal account using the virtual object last time is inconsistent with a weight parameter of acquiring an optimal account using the virtual object before the last time, a frequency at which an optimal account is acquired using the virtual object before the last time is multiplied by the weight parameter of acquiring an optimal account using the virtual object before the last time, and a product is added with the weight parameter of acquiring an optimal account using the virtual object last time to obtain an account weight parameter of the virtual object.

Exemplarily, the weight parameter of acquiring an optimal account using the virtual object last time is 0.5, the weight parameter of acquiring an optimal account using the virtual object before the last time is 0.1, the frequency at which an optimal account is acquired using the virtual object is 10, and then the account weight parameter of the virtual object is (10−1)*0.1+0.5=1.4.

The account weight parameter of the virtual object may be determined in any one of the above-mentioned manners, and this is not limited in the embodiments of the disclosure.

When a plurality of virtual objects are acquired by the account in the second application, the determining process of the account weight parameter of each virtual object is consistent with the above-mentioned determining process of the account weight parameter of the virtual object, and will not be described in detail herein.

In some embodiments, there may be two manners of determining a resource weight parameter of the virtual object based on a frequency at which a virtual resource is acquired for the virtual object.

In manner 1, a weight parameter of acquiring a virtual resource for the virtual object each time is consistent, and a product of the weight parameter of acquiring a virtual resource for the virtual object and a frequency at which a virtual resource is acquired for the virtual object is determined as a resource weight parameter of the virtual object.

Exemplarily, the weight parameter of acquiring a virtual resource for the virtual object each time is 0.1, the frequency at which a virtual resource is acquired for the virtual object is 10, the weight parameter of acquiring a virtual resource for the virtual object each time is multiplied by the frequency at which a virtual resource is acquired for the virtual object to obtain 0.1*10=1.0, and 1.0 is taken as a resource weight parameter of the virtual object.

In manner 2, a weight parameter of acquiring a virtual resource for the virtual object last time is inconsistent with a weight parameter of acquiring a virtual resource for the virtual object before the last time, a frequency at which a virtual resource is acquired for the virtual object before the last time is multiplied by the weight parameter of acquiring a virtual resource for the virtual object before the last time, and a product is added with the weight parameter of acquiring a virtual resource for the virtual object last time to obtain a resource weight parameter of the virtual object.

Exemplarily, the weight parameter of acquiring a virtual resource for the virtual object last time is 0.5, the weight parameter of acquiring a virtual resource for the virtual object before the last time is 0.1, the frequency at which a virtual resource is acquired for the virtual object is 10, and then the resource weight parameter of the virtual object is (10−1)*0.1+0.5=1.4.

The resource weight parameter of the virtual object may be determined in any one of the above-mentioned manners, and this is not limited in the embodiments of the disclosure.

When a plurality of virtual objects are acquired by the account in the second application, the determining process of the resource weight parameter of each virtual object is consistent with the above-mentioned determining process of the resource weight parameter of the virtual object, and will not be described in detail herein.

In some embodiments, there may be two manners of determining a level weight parameter of the virtual object based on a frequency at which an account level changes using the virtual object.

In the first manner, a weight parameter with which an account level changes using the virtual object each time is consistent, and a product of the weight parameter with which an account level changes using the virtual object and a frequency at which an account level changes using the virtual object is determined as a level weight parameter of the virtual object.

Exemplarily, the weight parameter with which an account level changes using the virtual object each time is 0.1, the frequency at which an account level changes using the virtual object is 10, the weight parameter with which an account level changes using the virtual object each time is multiplied by the frequency at which an account level changes using the virtual object to obtain 0.1*10=1, and 1 is taken as a level weight parameter of the virtual object.

In the second manner, a weight parameter with which an account level changes using the virtual object last time is inconsistent with a weight parameter with which an account level changes using the virtual object before the last time, a frequency at which an account level changes using the virtual object before the last time is multiplied by the weight parameter with which an account level changes using the virtual object before the last time, and a product is added with the weight parameter with which an account level changes using the virtual object last time to obtain a level weight parameter of the virtual object.

Exemplarily, the weight parameter with which an account level changes using the virtual object last time is 0.5, the weight parameter with which an account level changes using the virtual object before the last time is 0.1, the frequency at which an account level changes using the virtual object is 10, and then the level weight parameter of the virtual object is (10−1)*0.1+0.5=1.4.

The level weight parameter of the virtual object may be determined in any one of the above-mentioned manners, and this is not limited in the embodiments of the disclosure.

When a plurality of virtual objects are acquired by the account in the second application, the determining process of the level weight parameter of each virtual object is consistent with the above-mentioned determining process of the level weight parameter of the virtual object, and will not be described in detail herein.

In some embodiments, the process of determining matching degrees between the virtual objects acquired by the account and the account based on the object information of the virtual objects acquired by the account and the weight parameter corresponding to the object information is as follows: determining target values based on the object information of the virtual objects acquired by the account and the weight parameter corresponding to the object information; and determining the target values as matching degrees between the virtual objects and the account.

The target values are determined based on at least one of a first value, a second value, a third value, and a fourth value. The first value is determined based on the object type of the virtual object and the type weight parameter of the virtual object. The second value is determined based on the usage condition of the virtual object and the acquisition weight parameter of the virtual object. The third value is determined based on the acquisition duration of the virtual object and the duration weight parameter of the virtual object. The fourth value is determined based on at least one of the account weight parameter of the virtual object, the resource weight parameter of the virtual object and the level weight parameter of the virtual object.

In some embodiments, when the object information of the virtual object includes only an object type of the virtual object, the target value is determined based only on a first value corresponding to the virtual object. When the object information of the virtual object includes an object type and usage condition of the virtual object, the target value is determined based on a first value and a second value corresponding to the virtual object. When the object information of the virtual object includes an object type, usage condition and acquisition duration of the virtual object, the target value is determined based on a first value, a second value and a third value corresponding to the virtual object. When the object information of the virtual object includes at least one of a frequency at which an optimal account is acquired using the virtual object, a frequency at which a virtual resource is acquired for the virtual object, and a frequency at which an account level changes using the virtual object, and an object type, usage condition and acquisition duration of the virtual object, the target value is determined based on a first value, a second value, a third value, and a fourth value corresponding to the virtual object.

In some embodiments, in response to an example where the object information of the virtual object includes an object type of the virtual object, a usage condition of the virtual object, an acquisition duration of the virtual object, a frequency at which an optimal account is acquired using the virtual object, a frequency at which a virtual resource is acquired for the virtual object, and a frequency at which an account level changes using the virtual object, the process of determining a target value corresponding to the virtual object based on the object information of the virtual object and the weight parameter corresponding to the object information includes the following operations 1 to 5.

Operation 1: Determine a first value corresponding to the virtual object based on the object type of the virtual object and the type weight parameter of the virtual object.

In some embodiments, virtual objects of different object types correspond to different type values, and the type value corresponding to the virtual object of each object type is determined by the developer of the second application or the developer of the first application, and this is not limited in the embodiments of the disclosure. Based on the object type of the virtual object, a type value of the virtual object is determined, and a product of the type value of the virtual object and the type weight parameter of the virtual object is determined as a first value corresponding to the virtual object.

Exemplarily, a strength-type object corresponds to a type value of 50, an intelligence-type object corresponds to a type value of 60, and a feedback-type object corresponds to a type value of 40. If the object type of the virtual object is an intelligence type, the type value corresponding to the virtual object is 60. According to Table 1, it may be determined that the type weight parameter of the virtual object is 0.5, and the type value corresponding to the virtual object is multiplied by the type weight parameter of the virtual object to obtain 60*0.5=30. That is to say, the first value corresponding to the virtual object is 30.

Operation 2: Determine a second value corresponding to the virtual object based on the usage condition of the virtual object and the win weight parameter of the virtual object.

In some embodiments, a win probability of the virtual object is determined based on the usage condition of the virtual object, and a product of the win probability of the virtual object and the win weight parameter of the virtual object is determined as a second value corresponding to the virtual object.

Exemplarily, the usage condition of the virtual object is: the frequency at which the game is played using the virtual object is 8, the frequency at which the game wins is 3, the win probability of the virtual object is 0.375, the win weight parameter of the virtual object is 0.6, and the win probability of the virtual object and the win weight parameter of the virtual object are multiplied to obtain 0.375*0.6=0.225. That is to say, the second value corresponding to the virtual object is 0.225.

Operation 3: Determine a third value corresponding to the virtual object based on the acquisition duration of the virtual object and the duration weight parameter of the virtual object.

In some embodiments, a product of the acquisition duration of the virtual object and the duration weight parameter of the virtual object is determined as a third value corresponding to the virtual object.

Exemplarily, the acquisition duration of the virtual object is 30 min, the duration weight parameter of the virtual object is 0.5, and the acquisition duration of the virtual object and the duration weight parameter of the virtual object are multiplied to obtain 30*0.5=15. That is to say, the third value corresponding to the virtual object is 15.

Operation 4: Determine a fourth value corresponding to the virtual object based on the account weight parameter of the virtual object, the resource weight parameter of the virtual object and the level weight parameter of the virtual object.

In some embodiments, the sum of the account weight parameter of the virtual object, the resource weight parameter of the virtual object, and the level weight parameter of the virtual object is determined as a fourth value corresponding to the virtual object.

Exemplarily, the account weight parameter of the virtual object is 1.4, the resource weight parameter of the virtual object is 1.4, and the level weight parameter of the virtual object is 1.4. The account weight parameter of the virtual object, the resource weight parameter of the virtual object, and the level weight parameter of the virtual object are added to obtain 1.4+1.4+1.4=4.2. That is to say, the fourth value corresponding to the virtual object is 4.2.

Operation 5: Determine a target value corresponding to the virtual object based on the first value, the second value, the third value, and the fourth value corresponding to the virtual object.

In some embodiments, a target value corresponding to the virtual object is determined based on the first value, the second value, the third value, and the fourth value corresponding to the virtual object according to the following formula (1).

Hᵢ=Tᵢ+Wᵢ+Lᵢ+K*Aᵢ (1)

In the above-mentioned formula (1), Hᵢ is a target value corresponding to an i^{th} (i is an integer not less than 1) virtual object, Tᵢ is a first value corresponding to the ith virtual object, Wᵢ is a second value corresponding to the ith virtual object, Lᵢ is a third value corresponding to the ith virtual object, Aᵢ is a fourth value corresponding to the ith virtual object, K is a custom parameter, the value range of K is [0, 1], K may be set by the developer of the first application, K may also be adjusted according to a use scenario, and the value of K is not limited in the disclosure.

Exemplarily, in response to the value of K being 0.8, the first value, the second value, the third value, and the fourth value corresponding to the virtual object determined based on the above-mentioned operations 1 to 4 are 30, 0.225, 15, and 4.2 respectively, and Hᵢ=30+0.225+15+0.8*4.2=48.585 is obtained according to the above-mentioned formula (1). That is to say, the target value corresponding to the virtual object is 48.585.

The above operations 1 to 5 introduce the process of determining a target value corresponding to the virtual object based on the object information of the virtual object and the weight parameter corresponding to the object information only in response to an example where the object information of the virtual object includes an object type of the virtual object, a usage condition of the virtual object, an acquisition duration of the virtual object, a frequency at which an optimal account is acquired using the virtual object, a frequency at which a virtual resource is acquired for the virtual object, and a frequency at which an account level changes using the virtual object. The embodiments of the disclosure are not limited thereto. The object information of the virtual object may also be other conditions. The process of determining a target value corresponding to the virtual object based on the object information of the virtual object and the weight parameter corresponding to the object information is flexibly adjusted as the condition of the object information of the virtual object changes.

Exemplarily, the object information of the virtual object may also only include an object type of the virtual object and a usage condition of the virtual object. In this case, the process of determining a target value corresponding to the virtual object based on the object information of the virtual object and the weight parameter corresponding to the object information includes: determining a first value corresponding to the virtual object based on the object type of the virtual object and the type weight parameter of the virtual object; determining a second value corresponding to the virtual object based on the usage condition of the virtual object and the win weight parameter of the virtual object; and determining a target value corresponding to the virtual object based on the first value and the second value.

Exemplarily, the implementation process of determining a target value corresponding to the virtual object based on the first value and the second value includes, but is not limited to: taking a sum of the first value and the second value as a target value; taking a product of the first value and the second value as a target value; or calculating a product of the first value and a first weight and a product of the second value and a second weight respectively, and taking a sum of the two products as a target value. The first weight and the second weight are set empirically, or adjusted flexibly according to an application scenario. This is not limited by the embodiments of the disclosure.

In some embodiments, after determining a target value corresponding to the virtual object based on the object information of the virtual object and the weight parameter corresponding to the object information, the target value is determined as a matching degree between the virtual object and the account. For example, if the target value corresponding to the virtual object is 48.585, the matching degree between the virtual object and the account is 48.585.

When a plurality of virtual objects are acquired by the account in the second application, the determining process of the matching degree between each virtual object and the account is consistent with the above-mentioned determining process of the matching degree between the above-mentioned virtual object and the account, and will not be described in detail herein.

In some embodiments, after determining the matching degrees between the virtual objects acquired by the account in the second application and the account, the virtual object with the highest matching degree is determined as a target object.

In some embodiments, after acquiring virtual objects acquired by the account and object information of the virtual objects, it is also possible to directly determine a target object matching the account from the virtual objects acquired by the account based on the object information of the virtual objects acquired by the account without determining whether the number of virtual objects acquired by the account is less than a target number. That is to say, regardless of whether the number of virtual objects acquired by the account is less than a target number, a target object matching the account from the virtual objects acquired by the account is determined based on the object information of the virtual objects acquired by the account.

In some embodiments, the process of acquiring a multimedia resource corresponding to the second application based on the target object is: determining, based on the target object, a target skill among skills corresponding to the target object; acquiring a reference multimedia resource in a case that the target object casts the target skill; and fading the reference multimedia resource to obtain the multimedia resource corresponding to the second application, the fading being used for reducing pixel values of a background region in the reference multimedia resource.

In some embodiments, since the target object includes a plurality of skills and a multimedia resource when the target object casts a certain skill is displayed when displaying the multimedia resource, a target skill may be determined among the plurality of skills of the target object in the following three determining manners.

In the first determining manner, damages caused by the target object casting skills corresponding to the target object are determined based on the target object, and a skill with the highest damage is determined as the target skill.

In some embodiments, the implementation process of determining, based on the target object, damages caused by the target object casting skills corresponding to the target object and determining a skill with the highest damage as the target skill includes: in response to the object information including damages caused by the virtual object casting various skills, determining, based on the target object, damages caused by the target object casting skills corresponding to the target object, and determining a skill with the highest damage as the target skill.

In some embodiments, the virtual object includes a plurality of skills with different damages. When the object information includes damages caused by the virtual object casting various skills, damages caused by the target object casting various skills may be determined based on the target object, and a skill with the highest damage may be determined as the target skill.

In some embodiments, the electronic device stores damages caused by various virtual objects casting skills corresponding to the virtual objects. After determining the target object, the electronic device determines, based on the target object, damages caused by the target object casting various skills of the target object, and determines a skill with the highest damage as the target skill.

In the second determining manner, the electronic device determines a target skill of the target object by means of transmitting a first acquisition request to a server. The acquisition request carries an object identifier of the target object.

In some embodiments, the server stores the damages caused by various virtual objects casting skills corresponding to the virtual objects. After determining the target object, the electronic device transmits a first acquisition request to the server. The first acquisition request carries an object identifier of the target object, and the object identifier may be an object name of the target object, and may also be other identifiers capable of uniquely representing the target object. This is not limited in the embodiments of the disclosure. After receiving the first acquisition request, the server parses the first acquisition request to obtain an object identifier carried in the first acquisition request, determines a target object based on the object identifier, acquires damages caused by the target object casting various skills of the target object, determines a target skill based on the damages caused by the target object casting various skills of the target object, and transmits the target skill to the electronic device. That is to say, the electronic device determines the target skill.

In some embodiments, after acquiring damages caused by the target object casting various skills of the target object, the server may directly transmit the damages caused by the target object casting various skills of the target object to the electronic device, and the electronic device determines a target skill among the various skills of the target object based on the damages caused by the target object casting various skills of the target object.

When the target skill is determined in the second determining manner, since it is not necessary to store damages caused by casting skills corresponding to various virtual objects in the electronic device, the storage space of the electronic device may be saved. However, it is necessary to transmit an acquisition request to the server by the electronic device, thereby resulting in a long time to acquire the target skill. When the target skill is determined in the first determining manner, since damages caused by casting skills corresponding to various virtual objects are stored in the electronic device, the storage space of the electronic device will be occupied. Meanwhile, the time of acquiring the target skill may be reduced. Therefore, the above-mentioned first and second determining manners have both advantages and disadvantages. When the object information includes damages caused by the virtual object casting various skills, either manner may be selected to determine the target skill. This is not limited in the embodiments of the disclosure.

Exemplarily, the target object includes three skills, i.e. skill 1, skill 2 and skill 3. Damage caused by the target object casting skill 1 is 30, damage caused by the target object casting skill 2 is 40, and damage caused by the target object casting skill 3 is 50. Since the damage caused by the target object casting skill 3 is the highest, skill 3 is determined as the target skill.

In the third determination manner, frequencies at which the target object casts skills corresponding to the target object are determined based on the target object, and a skill cast at the maximum frequency is determined as the target skill.

In some embodiments, the implementation process of determining, based on the target object, frequencies at which the target object casts skills corresponding to the target object, and determining a skill cast at the maximum frequency as the target skill includes: in response to the object information including frequencies at which the virtual object casts various skills, determining, based on the target object, frequencies at which the target object casts skills corresponding to the target object, and determining a skill cast at the maximum frequency as the target skill.

In some embodiments, the virtual object includes a plurality of skills, and frequencies at which the virtual object casts various skills may or may not be the same. When the object information includes frequencies at which the virtual object casts various skills and the frequencies at which the virtual object casts various skills are different, frequencies at which the target object casts various skills are determined based on the target object, and a skill cast at the maximum frequency is determined as the target skill.

In some embodiments, when the object information includes frequencies at which the virtual object casts various skills and the frequencies at which the virtual object casts various skills are the same, a skill is randomly determined as the target skill among the plurality of skills corresponding to the target object based on the target object.

The frequencies at which the virtual object casts various skills may be frequencies at which an account identical to the account logged in the first application casts various skills using the virtual object and may also be frequencies at which the account logged in the second application casts various skills using the virtual object. This is not limited in the disclosure.

In some embodiments, the electronic device stores a multimedia resource when the target object casts each skill of the target object. After determining the target object and the target skill of the target object, the electronic device acquires the multimedia resource when the target object casts the target skill of the target object from the stored multimedia resource when the target object casts each skill of the target object. That is to say, the electronic device acquires a reference multimedia resource when the target object casts the target skill.

In some embodiments, the server stores a multimedia resource when each virtual object casts each skill of the virtual object. After the electronic device determines the target object and the target skill of the target object, the electronic device transmits a second acquisition request to the server. The second acquisition request carries an object identifier of the target object and a skill identifier of the target skill. The server receives a second acquisition request, parses the second acquisition request to obtain an object identifier of the target object and a skill identifier of the target skill carried in the second acquisition request, extracts a multimedia resource when the target object casts each skill of the target object based on the object identifier of the target object, and extracts a multimedia resource when the target object casts the target skill from the multimedia resource when the target object casts each skill of the target object based on the skill identifier of the target skill. The server transmits the multimedia resource when the target object casts the target skill to the electronic device. That is to say, the electronic device acquires a reference multimedia resource when the target object casts the target skill.

In some embodiments, the reference multimedia resource includes a background region and a region where the target object is located, and the background region refers to a region other than the region where the target object is located. After a reference multimedia resource is acquired, the reference multimedia resource is faded to obtain a multimedia resource corresponding to the second application. The fading process is used for reducing pixel values of a background region in the reference multimedia resource. Since the pixel values of the background region are reduced, pixel values of a region where the target object is located in the reference multimedia resource will be higher visually, so that the target object in the reference multimedia resource is more prominent.

In some embodiments, in response to one second application installed in the electronic device, the electronic device acquires a multimedia resource corresponding to the second application, and takes the multimedia resource corresponding to the second application as a displayed multimedia resource. For example, the multimedia resource corresponding to the second application is taken as a multimedia resource-to-be-displayed. In response to a plurality of second applications installed in the electronic device, the electronic device acquires a multimedia resource corresponding to each of the second applications, respectively determines an operation time when a first operation on each of the second applications is received last time, and determines the multimedia resource corresponding to the second application with the operation time satisfying a time requirement as a displayed multimedia resource. For example, the multimedia resource corresponding to the second application with the operation time satisfying the time requirement is taken as a multimedia resource-to-be-displayed.

Exemplarily, the operation time satisfying the time requirement is the earliest operation time or the latest operation time. This is not limited in the embodiments of the disclosure. The operation time of the first operation on each second application is time when the second application is opened.

In some embodiments, the multimedia resource may be a moving picture, a picture and a video, and the form of the multimedia resource is not limited in the embodiments of the disclosure.

In operation 202, an operation instruction for the first application is acquired, the operation instruction is executed in the first application, and the multimedia resource is displayed.

In some embodiments, an operation instruction for the first application is acquired, the operation instruction is executed in the first application, and the multimedia resource is displayed by means of outward diffusion by taking an operation control displayed on a display interface of the first application as a reference point.

In some embodiments, before the multimedia resource is displayed by means of outward diffusion by taking the operation control displayed on the display interface of the first application as the reference point, it is also necessary to determine whether the acquired multimedia resource is complete. In response to the acquired multimedia resource being complete, the multimedia resource is displayed by means of outward diffusion by taking the operation control displayed on the display interface of the first application as the reference point.

In some embodiments, in response to the acquired multimedia resource being complete, the transparency of the multimedia resource may also be adjusted to obtain an adjusted multimedia resource, and the adjusted multimedia resource is displayed by means of outward diffusion by taking the operation control displayed on the display interface of the first application as the reference point.

In some embodiments, when the multimedia resource is acquired, an original hash of the multimedia resource is also acquired. The process of determining whether the acquired multimedia resource is complete is: determining a hash corresponding to the multimedia resource, in response to the hash corresponding to the multimedia resource being consistent with the original hash of the multimedia resource, determining that the acquired multimedia resource is complete, and in response to the hash corresponding to the multimedia resource being inconsistent with the original hash of the multimedia resource, determining that the acquired multimedia resource is incomplete. When the acquired multimedia resource is incomplete, the multimedia resource is not displayed.

In some embodiments, the original transparency of the multimedia resource corresponding to the second application is 100. That is to say, the multimedia resource corresponding to the second application is completely opaque before being adjusted. The transparency of the multimedia resource is adjusted to reduce the transparency of the multimedia resource so as to obtain an adjusted multimedia resource. For example, the transparency of the multimedia resource is adjusted to 70-80. The transparency of the adjusted multimedia resource is reduced. That is to say, the adjusted multimedia resource is not fully displayed, and the adjusted multimedia resource is more transparent. In this way, when displaying the adjusted multimedia resource, the display of the content in the display interface of the first application is less influenced.

In some embodiments, an operation control is displayed on the display interface of the first application. The operation control may be a like control or a favorite control or a forward control. This is not limited in the embodiments of the disclosure. The operation instruction for the first application includes, but is not limited to, a like instruction, a favorite instruction and a forward instruction. For example, the operation instruction for the first application is a like instruction which is any one of triggering a like control displayed on the display interface of the first application and triggering the display interface of the first application at a first frequency. For example, the like instruction for the first application is to trigger a like control displayed on the display interface of the first application. For example, the like instruction for the first application is to double-click the display interface of the first application.

In some embodiments, the adjusted multimedia resource is displayed by means of outward diffusion by taking the operation control displayed on the display interface of the first application as the reference point when displaying the multimedia resource. Exemplarily, the adjusted multimedia resource is displayed by means of outward diffusion by taking the like control displayed on the display interface of the first application as the reference point.

Exemplarily, displaying the multimedia resource (an unadjusted multimedia resource or an adjusted multimedia resource) by means of outward diffusion by taking the operation control displayed on the display interface of the first application as the reference point refers to displaying the multimedia resource by means of diffusion toward a middle region of the display interface of the first application by taking the operation control displayed on the display interface of the first application as the reference point, whereby the multimedia resource is displayed in the middle region of the display interface of the first application in an overlay manner. Exemplarily, the process of displaying the multimedia resource by means of outward diffusion by taking the operation control displayed on the display interface of the first application as the reference point is a process of dynamically displaying the multimedia resource.

In some embodiments, the process of acquiring an operation instruction for the first application and executing the operation instruction in the first application is: displaying the operation control displayed on the display interface of the first application in a target form. The target form is a form different from a default display form of the operation control displayed on the display interface of the first application, and the target form is set empirically, or adjusted flexibly according to an application scenario. This is not limited by the embodiments of the disclosure. For example, the operation instruction for the first application is a like instruction, the default display form of the like control displayed on the display interface of the first application is displaying with white, and then the target form may refer to displaying with gray, i.e. displaying the like control of the first application as gray.

In some embodiments, during the display of the multimedia resource, a second operation on the multimedia resource is acquired, and the display of the multimedia resource is controlled to be canceled. The second operation is used for instructing to stop displaying the multimedia resource, and the second operation includes any one of triggering a multimedia resource display region at a second frequency and triggering an operation control displayed on a display interface of the first application at a third frequency. For example, the second operation is double-clicking on a multimedia resource display region. For example, the second operation is double-clicking on the operation control displayed on the display interface of the first application. The second frequency and the third frequency may or may not be the same frequency, and this is not limited in the embodiments of the disclosure.

In some embodiments, in response to not acquiring a second operation on the multimedia resource during the display of the multimedia resource and a display duration of the multimedia resource satisfying duration requirements, the operation control displayed on the display interface of the first application is taken as the reference point, and the display of the multimedia resource is controlled to be canceled by incorporating the multimedia resource into the operation control. The second operation is used for instructing to stop displaying the multimedia resource. Exemplarily, the display duration of the multimedia resource satisfying the duration requirement refers to that the display duration of the multimedia resource reaches a duration threshold. The duration threshold is set empirically as, for example, 5 seconds.

The manner of taking the operation control displayed on the display interface of the first application as the reference point and controlling the display of the multimedia resource to be canceled by incorporating the multimedia resource into the operation control is a manner of dynamically canceling the display of the multimedia resource with a good visual effect. That is to say, when the multimedia resource automatically disappears (the display duration of the multimedia resource satisfies the duration requirement), the manner of canceling the display of the multimedia resource has a dynamic effect. When the multimedia resource is forced to disappear (the second operation on the multimedia resource), the manner of canceling the display of the multimedia resource has no dynamic effect.

In some embodiments, a display switch of the multimedia resource may also be provided in a setting page of the electronic device. When the display switch of the multimedia resource is on, the multimedia resource is displayed when the operation instruction for the first application is acquired. When the display switch of the multimedia resource is off, the multimedia resource is not displayed when the operation instruction for the first application is acquired.

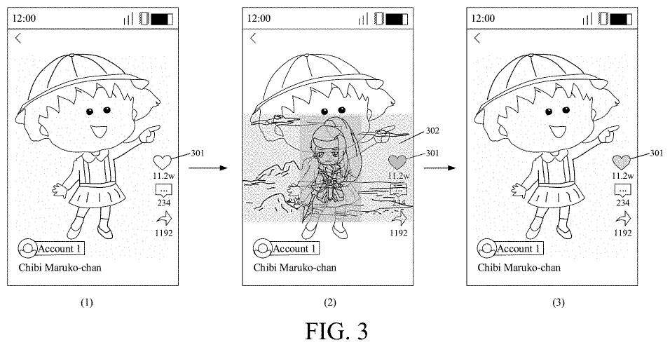

In response to an example where the first application is a short video type application, a short video is displayed in the display interface of the first application. FIG. 3 shows a schematic diagram of a display process of a multimedia resource according to some embodiments of the disclosure. A short video and an operation control (a heart-shaped like control 301) are displayed in in display (1) of FIG. 3. In response to acquiring a like instruction for the first application, display (2) is displayed. The heart-shaped like control 301 in display (2) is in a selected state (the heart-shaped like control 301 turns gray), and a multimedia resource 302 is displayed on the short video. When the display duration of the multimedia resource satisfies the duration requirement or a second operation on the multimedia resource is acquired, the display of the multimedia resource is canceled. As shown in display (3), the display of the multimedia resource is canceled, but the like control 301 remains in a selected state (the like control 301 is still gray).

In some embodiments, in order to improve the feeling of freshness for users, each time a first operation on a first application is received (i.e. each time the first application is opened), a multimedia resource is acquired once. When an operation instruction for the first application is acquired, the multimedia resource acquired at this time is displayed. In this way, multimedia resources acquired after each time the first application is opened may be different, so that the multimedia resources displayed after the operation instruction for the first application is acquired are different, the curiosity of the users may be aroused, and the user retention rate is high.

According to the above-mentioned method, after an operation instruction for a first application is acquired, not only the operation instruction is executed in the first application, but also a multimedia resource is additionally displayed. The multimedia resource is determined based on historical data of the same account logged in a second application. In this way, control modes for the first application are diversified and more flexible, the interaction between users and electronic devices is improved, the experience of users is better, the retention rate of users may be improved, and the user attrition rate of the first application may be reduced.

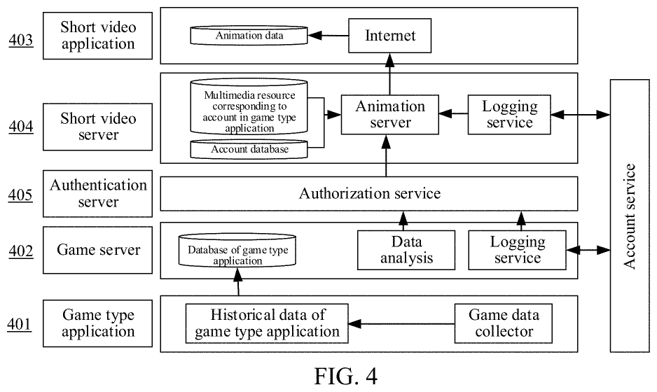

FIG. 4 shows a flowchart of an application control method according to some embodiments of the disclosure. FIG. 4 is illustrated with an example where the first application is a short video application and the second application is a game type application. FIG. 4 includes a game type application 401, a game server 402, a short video application 403, a short video server 404, and an authentication server 405. The authentication server 405 is configured to authorize the short video application 403 to acquire a multimedia resource of the game type application. An account logged in the short video application 403 and an account logged in the game type application 401 are the same account. The process of logging in the account in the short video application 403 is realized through a logging service in the short video server. The process of logging in the account in the game type application is realized through a logging service in the game server 402. Through an account service, the account logged in the short video application 403 and the account logged in the game type application 401 may be the same account.

The game type application 401 collects historical data of each account logged in the game type application 401 based on a game data collector. The game server 402 analyzes the historical data of each account based on the historical data of each account and a database of the game type application 401, so as to obtain a reference multimedia resource corresponding to each account. The database of the game type application 401 includes a reference multimedia resource when each object casts each skill.

The process of collecting historical data of each account logged in the game type application 401 by the game type application is performed with user authorization. Exemplarily, before the game type application 401 collects historical data of any account logged in the game type application 401, a data acquisition authorization box is displayed. The data acquisition authorization box includes prompt information, a grant authorization option and a deny authorization option. The prompt information is used for asking whether a user corresponding to any account grants authorization to acquire data. After acquiring a trigger operation for the grant authorization option in the data acquisition authorization box, the game type application 401 re-collects historical data of any account logged in the game type application 401. If acquiring a trigger operation for the deny authorization option in the data acquisition authorization box, the game type application 401 cannot collect historical data of any account logged in the game type application 401.

The short video server 404 determines a reference multimedia resource corresponding to the account logged in the short video application 403 based on the account data of the account logged in the short video application 403 and the reference multimedia resource corresponding to each account determined by the game server 402. The short video server processes the reference multimedia resource corresponding to the account logged in the short video application 403 based on an animation server to obtain a multimedia resource corresponding to the account logged in the short video application 403, and then displays the multimedia resource in the short video application 403 via the Internet. Exemplarily, the multimedia resource is in the form of an animation.

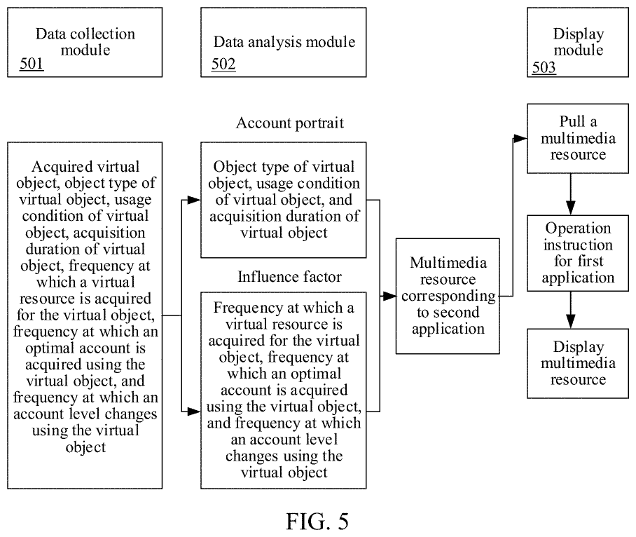

FIG. 5 shows a schematic architectural diagram of an application control method according to some embodiments of the disclosure. In FIG. 5, a data collection module 501, a data analysis module 502 and a display module 503 are included.

The data collection module 501 is configured to collect historical data of an account in a second application. The historical data includes virtual objects acquired by the account in the second application and object information of the virtual objects. The object information includes an acquired virtual object, an object type of the virtual object, a usage condition of the virtual object, an acquisition duration of the virtual object, a frequency at which a virtual resource is acquired for the virtual object, a frequency at which an optimal account is acquired using the virtual object, and a frequency at which an account level changes using the virtual object.

The data analysis module 502 is configured to determine an account portrait and an influence factor based on the object information of the virtual objects. The account portrait includes an object type of the virtual object, a usage condition of the virtual object and an acquisition duration of the virtual object. The influence factor includes a frequency at which a virtual resource is acquired for the virtual object, a frequency at which an optimal account is acquired using the virtual object, and a frequency at which an account level changes using the virtual object. The data analysis module 502 is further configured to determine a multimedia resource corresponding to the second application based on the account portrait and the influence factor.

The display module 503 is configured to pull the multimedia resource of the second application obtained by the data analysis module 502, and display the multimedia resource after acquiring an operation instruction for a first application.

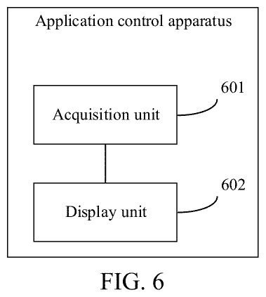

FIG. 6 shows a schematic structural diagram of an application control apparatus according to some embodiments of the disclosure. As shown in FIG. 6, the apparatus includes:

an acquisition processor 601, configured to acquire a multimedia resource that is determined based on historical data of an account logged in a second application, the account logged in the second application being the same as an account logged in a first application; and

a display processor 602, configured to acquire an operation instruction for the first application, execute the operation instruction in the first application, and display the multimedia resource.

In some embodiments, the acquisition processor 601 is configured to acquire historical data. The historical data includes virtual objects acquired by an account logged in a second application and object information of the virtual objects.

The apparatus further includes:

a determining processor, configured to determine, in response to the number of virtual objects acquired by the account being not less than a target number, a target object matching the account from the virtual objects acquired by the account based on the object information of the virtual objects acquired by the account; and

an acquisition processor 601, configured to acquire a multimedia resource based on the target object.

In some embodiments, the determining processor is configured to determine a weight parameter corresponding to the object information based on the object information of the virtual objects acquired by the account; determine matching degrees between the virtual objects acquired by the account and the account based on the object information of the virtual objects acquired by the account and the weight parameter corresponding to the object information; and take a virtual object with the highest matching degree among the virtual objects acquired by the account as the target object.

In some embodiments, the display processor 602 is configured to display the multimedia resource by means of outward diffusion by taking an operation control displayed on a display interface of the first application as a reference point.

In some embodiments, the determining processor is configured to determine a hash corresponding to the multimedia resource.

The display processor 602 is configured to display the multimedia resource by means of outward diffusion by taking the operation control displayed on the display interface of the first application as the reference point in response to the hash corresponding to the multimedia resource being consistent with an original hash of the multimedia resource; or, adjust the transparency of the multimedia resource to obtain an adjusted multimedia resource in response to the hash corresponding to the multimedia resource being consistent with the original hash of the multimedia resource, and display the adjusted multimedia resource by means of outward diffusion by taking the operation control displayed on the display interface of the first application as the reference point.

In some embodiments, the apparatus further includes:

a control processor, configured to acquire, during the display of the multimedia resource, a second operation on the multimedia resource, and control to cancel the display of the multimedia resource, the second operation being used for instructing to stop displaying the multimedia resource and the second operation including any one of triggering a multimedia resource display region at a second frequency and triggering an operation control displayed on a display interface of the first application at a third frequency.

In some embodiments, the control processor is further configured to, in response to not acquiring a second operation on the multimedia resource during the display of the multimedia resource and a display duration of the multimedia resource satisfying duration requirements, take an operation control displayed on a display interface of the first application as a reference point, and control to cancel the display of the multimedia resource by incorporating the multimedia resource into the operation control, the second operation being used for instructing to stop displaying the multimedia resource.

In some embodiments, the object information includes at least one of an object type of the virtual object, a usage condition of the virtual object, an acquisition duration of the virtual object, a frequency at which an optimal account is acquired using the virtual object, a frequency at which a virtual resource is acquired for the virtual object, and a frequency at which an account level changes using the virtual object.

In some embodiments, the determining processor is configured to determine a type weight parameter of the virtual object based on an object type of the virtual object; determine a win weight parameter of the virtual object based on a usage condition of the virtual object; determine a duration weight parameter of the virtual object based on an acquisition duration of the virtual object; determine an account weight parameter of the virtual object based on a frequency at which an optimal account is acquired using the virtual object; determine a resource weight parameter of the virtual object based on a frequency at which a virtual resource is acquired for the virtual object; and determine a level weight parameter of the virtual object based on a frequency at which an account level changes using the virtual object.

In some embodiments, the determining processor is configured to determine target values based on the object information of the virtual objects acquired by the account and the weight parameter corresponding to the object information; and determine the target values as matching degrees between the virtual objects and the account. The target values are determined based on at least one of a first value, a second value, a third value, and a fourth value. The first value is determined based on the object type of the virtual object and the type weight parameter of the virtual object. The second value is determined based on the usage condition of the virtual object and the win weight parameter of the virtual object. The third value is determined based on the acquisition duration of the virtual object and the duration weight parameter of the virtual object. The fourth value is determined based on at least one of the account weight parameter of the virtual object, the resource weight parameter of the virtual object and the level weight parameter of the virtual object.

In some embodiments, the acquisition processor 601 is further configured to acquire virtual resource acquisition frequencies of a plurality of virtual objects included in the second application in response to the number of virtual objects acquired by the account being less than the target number.

The determining processor is configured to determine a virtual object having the maximum virtual resource acquisition frequency among the plurality of virtual objects as the target object.

In some embodiments, the determining processor is configured to determine, based on the target object, a target skill among skills corresponding to the target object.

The acquisition processor 601 is configured to acquire a reference multimedia resource in a case that the target object casts the target skill; and fade the reference multimedia resource to obtain the multimedia resource, the fading being used for reducing pixel values of a background region in the reference multimedia resource.

In some embodiments, the determining processor is configured to determine, based on the target object, damages caused by the target object casting skills corresponding to the target object, and determine a skill with the highest damage as the target skill;

or determine, based on the target object, frequencies at which the target object casts skills corresponding to the target object, and determine a skill cast at the maximum frequency as the target skill.

In some embodiments, the acquisition processor 601 is further configured to acquire, in response to a plurality of second applications, multimedia resources respectively corresponding to the plurality of second applications; respectively determine operation times at which first operations for the plurality of second applications are last received; and determine a multimedia resource corresponding to a second application with an operation time satisfying a time requirement as the multimedia resource.

In some embodiments, the first application is any one of a short video type application, a social application type application, an information management type application, and a life encyclopedia type application, and the second application is any one of a game type application and a video playing type application.

According to the above-mentioned apparatus, after an operation instruction for a first application is acquired, not only the operation instruction is executed in the first application, but also a multimedia resource is additionally displayed. The multimedia resource is determined based on historical data of the same account logged in a second application. In this way, control modes for the first application are diversified and more flexible, the interaction between users and electronic devices is improved, the experience of users is better, the retention rate of users may be improved, and the user attrition rate of the first application may be reduced.

It is to be understood that, the apparatus provided in FIG. 6 implements functions of the apparatus, the division of the foregoing functional processors is merely an example for description. In the practical application, the functions may be assigned to and completed by different functional processors according to the requirements, that is, the internal structure of the device is divided into different functional processors, to implement all or some of the functions described above. In addition, the apparatus and method embodiments provided in the foregoing embodiments belong to the same concept. For the specific implementation process, reference may be made to the method embodiments, and details are not described herein again.

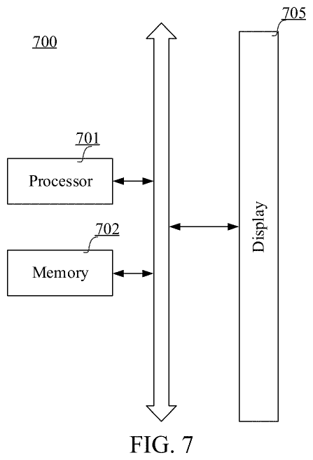

FIG. 7 shows a structural block diagram of an electronic device 700 according to an exemplary embodiment of the disclosure. The electronic device 700 may be a portable mobile terminal, such as a smartphone, a tablet computer, a Moving Picture Experts Group Audio Layer III (MP3) player, a Moving Picture Experts Group Audio Layer IV (MP4) player, a notebook computer, or a desktop computer. The electronic device 700 may also be referred to as another name such as user equipment, a portable terminal, a laptop terminal, or a desktop terminal.

The electronic device 700 usually includes a processor 701 and a memory 702.

The processor 701 may include one or more processing cores, for example, a 4-core processor or an 8-core processor. The processor 701 may be implemented in at least one hardware form of a digital signal processor (DSP), a field-programmable gate array (FPGA), and a programmable logic array (PLA). In some embodiments, the processor 701 may include a main processor and a coprocessor. The main processor is configured to process data in an awake state, also referred to as a central processing processor (CPU). The coprocessor is a low-power processor configured to process data in a standby state. In some embodiments, the processor 701 may be integrated with a graphics processing processor (GPU). The GPU is configured to render and draw content that needs to be displayed on a display. In some embodiments, the processor 701 may further include an artificial intelligence (AI) processor. The AI processor is configured to process computing operations related to machine learning.

The memory 702 may include one or more computer-readable storage media. The computer-readable storage medium may be non-transient. The memory 702 may further include a high-speed random access memory (RAM) and a nonvolatile memory, for example, one or more disk storage devices or flash storage devices. In some embodiments, the non-transitory computer-readable storage medium in the memory 702 is configured to store at least one instruction, the at least one instruction being executed by the processor 701 to implement the application control method for an application provided in the method embodiments of the disclosure.

In some embodiments, the electronic device 700 may include a display screen 705.

The display screen 705 is configured to display a user interface (UI). The UI may include a graphic, text, an icon, a video, and any combination thereof. When the display screen 705 is a touch display screen, the display screen 705 is also capable of capturing a touch signal on or above a surface of the display screen 705. The touch signal may be inputted to the processor 701 as a control signal for processing. In this case, the display screen 705 may be further configured to provide a virtual button and/or a virtual keyboard that are/is also referred to as a soft button and/or a soft keyboard. In some embodiments, there may be one display screen 705, disposed on a front panel of the electronic device 700. In some other embodiments, there are at least two display screens 705, disposed on different surfaces of the electronic device 700 respectively or in a folded design. In some other embodiments, the display screen 705 may be a flexible display screen, disposed on a curved surface or a folded surface of the electronic device 700. Even, the display screen 705 may be further set in a non-rectangular irregular pattern, namely, a special-shaped screen. The display screen 705 may be prepared by using materials such as a liquid-crystal display (LCD), an organic light-emitting diode (OLED), or the like.

A person skilled in the art may understand that a structure shown in FIG. 7 constitutes no limitation on the electronic device 700, and the electronic device may include more or fewer components than those shown in the figure, or some components may be combined, or a different component deployment may be used.

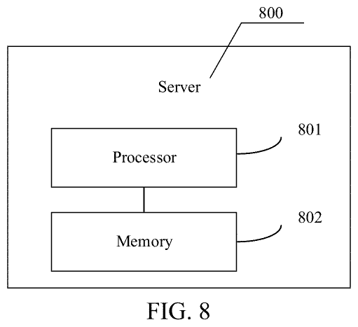

FIG. 8 is a schematic structural diagram of a server according to some embodiments of the disclosure. The server 800 may vary greatly because a configuration or performance varies, and may include one or more central processing processors (CPU) 801 and one or more memories 802. The one or more memories 802 store at least one computer program, and the at least one computer program is loaded and executed by the one or more processors 801 to implement the application control method provided in the foregoing various method embodiments. Certainly, the server 800 may also have a wired or wireless network interface, a keyboard, an input/output interface and other components to facilitate input/output. The server 800 may also include other components for implementing device functions. Details are not described herein again.

In an exemplary embodiment of the disclosure, a non-transitory computer-readable storage medium is provided, storing at least one computer program, the at least one computer program being loaded and executed by a processor to cause the computer to implement the application control method according to any one of the foregoing embodiments.

In some embodiments, the non-transitory computer-readable storage medium may be a read-only memory (ROM), a random access memory (random-access memory, RAM), a compact disc read-only memory (CD-ROM), a magnetic tape, a floppy disk, an optical data storage device, and the like.

In an exemplary embodiment of the disclosure, a computer program or a computer program product is further provided, the computer program or the computer program product storing at least one piece of computer instruction, the at least one piece of computer instruction being loaded and implemented by a processor to cause a computer to implement the application control method according to any one of the foregoing embodiments.

It is to be understood that, “A plurality of” mentioned in the specification means two or more. “And/or” describes an association relationship for describing associated objects and represents that three relationships may exist. For example, A and/or B may represent the following three cases: Only A exists, both A and B exist, and only B exists. The character “I” in this specification generally indicates an “or” relationship between the associated objects.

The foregoing descriptions are merely exemplary embodiments of the disclosure, but are not intended to limit the disclosure. Any modification, equivalent replacement, or improvement made within the principle of the disclosure shall fall within the protection scope of the disclosure.

What is claimed is:

1. An application control method, performed by an electronic device, the application control method comprising:
acquiring a multimedia resource, the multimedia resource being based on historical data of an account that is logged into a second application, the account being the same as an account that is logged into a first application; and
acquiring an operation instruction for the first application, executing the operation instruction in the first application, and displaying the multimedia resource.

2. The application control method according to claim 1, wherein the acquiring the multimedia resource comprises:
acquiring the historical data, the historical data comprising virtual objects acquired by the account that is logged into the second application and object information of the virtual objects;
determining, based on a number of the virtual objects being greater than or equal to a target number, a target object that matches the account from among the virtual objects according to the object information; and
acquiring the multimedia resource based on the target object.

3. The application control method according to claim 2, wherein the target object comprises:
determining a weight parameter corresponding to the object information;
determining matching degrees between the virtual objects acquired by the account that is based on the object information of the virtual objects acquired by the account, and the weight parameter corresponding to the object information; and
determining a virtual object with the highest matching degree among the virtual objects acquired by the account as the target object.

4. The application control method according to claim 1, wherein the displaying the multimedia resource comprises:
displaying the multimedia resource by outward diffusion using, as a reference point, an operation control that is displayed on a display interface of the first application.

5. The application control method according to claim 4, wherein the displaying the multimedia resource by outward diffusion comprises:
determining a hash corresponding to the multimedia resource;
displaying the multimedia resource by the outward diffusion, based on the hash corresponding to an original hash of the multimedia resource; or
adjusting a transparency of the multimedia resource to obtain an adjusted multimedia resource based on the hash corresponding to the original hash of the multimedia resource and displaying the adjusted multimedia resource by the outward diffusion.

6. The application control method according to claim 1, wherein after the displaying the multimedia resource, the method further comprises:
acquiring, during the display of the multimedia resource, a second operation on the multimedia resource, and controlling to cancel the display of the multimedia resource, the second operation being used for instructing to stop displaying the multimedia resource and the second operation comprising any one of triggering a multimedia resource display region at a second frequency and triggering an operation control displayed on a display interface of the first application at a third frequency.

7. The application control method according to claim 1, wherein after the displaying the multimedia resource, the method further comprises:
based on not acquiring a second operation on the multimedia resource during the display of the multimedia resource and based on a display duration of the multimedia resource meeting a minimum duration threshold, using an operation control displayed on a display interface of the first application as a reference point, and controlling to cancel the display of the multimedia resource by incorporating the multimedia resource into the operation control, the second operation being used for instructing to stop displaying the multimedia resource.

8. The application control method according to claim 2, wherein the object information comprises at least one of an object type of the virtual object, a usage condition of the virtual object, an acquisition duration of the virtual object, a frequency at which an optimal account is acquired using the virtual object, a frequency at which a virtual resource is acquired for the virtual object, and a frequency at which an account level changes using the virtual object.

9. The application control method according to claim 3, wherein the determining the weight parameter comprises at least one of the following:
determining a type weight parameter of the virtual object based on an object type of the virtual object;
determining a win weight parameter of the virtual object based on a usage condition of the virtual object;
determining a duration weight parameter of the virtual object based on an acquisition duration of the virtual object;
determining an account weight parameter of the virtual object based on a frequency at which an optimal account is acquired using the virtual object;
determining a resource weight parameter of the virtual object based on a frequency at which a virtual resource is acquired for the virtual object; and
determining a level weight parameter of the virtual object based on a frequency at which an account level changes using the virtual object.

10. The application control method according to claim 3, wherein the determining the matching degrees comprises:
determining target values based on the object information of the virtual objects acquired by the account and the weight parameter corresponding to the object information; and
determining the target values as the matching degrees between the virtual objects and the account,
the target values being determined based on at least one of a first value, a second value, a third value, and a fourth value, the first value being determined based on the object type of the virtual object and the type weight parameter of the virtual object, the second value being determined based on the usage condition of the virtual object and the win weight parameter of the virtual object, the third value being determined based on the acquisition duration of the virtual object and the duration weight parameter of the virtual object, and the fourth value being determined based on at least one of the account weight parameter of the virtual object, the resource weight parameter of the virtual object and the level weight parameter of the virtual object.

11. The application control method according to claim 2, further comprising:
acquiring virtual resource acquisition frequencies of a plurality of virtual objects comprised in the second application based on the number of the virtual being less than the target number; and
determining a virtual object with a maximum virtual resource acquisition frequency among the plurality of virtual objects as the target object.

12. The application control method according to claim 2, wherein the acquiring the multimedia resource comprises:
determining, based on the target object, a target skill among skills corresponding to the target object;
acquiring a reference multimedia resource when the target object performs the target skill; and
reducing pixel values of a background region in the reference multimedia resource to obtain the multimedia resource.

13. The application control method according to claim 12, wherein the determining the target skill comprises:
determining, based on the target object, damages caused by the target object performing skills corresponding to the target object, and determining a skill with the highest damage as the target skill; or
determining, based on the target object, frequencies at which the target object casts skills corresponding to the target object, and determining a skill cast at the maximum frequency as the target skill.

14. The application control method according to claim 1, wherein the acquiring the multimedia resource comprises:
acquiring, based on a plurality of second applications, multimedia resources respectively corresponding to the plurality of second applications;
respectively determining operation times at which first operations for the plurality of second applications are last received; and
determining a multimedia resource corresponding to a second application with an operation time meeting a minimum duration threshold as the multimedia resource.

15. The application control method according to claim 1, wherein the first application is any one of a short video type application, a social application type application, an information management type application, and a life encyclopedia type application, and the second application is any one of a game type application and a video playing type application.

16. An application control apparatus, comprising:
at least one memory configured to store program code; and
at least one processor configured to read the program code and operate as instructed by the program code, the program code comprising:
an acquisition code configured to cause at least one of the at least one processor to acquire a multimedia resource that is determined based on historical data of an account logged in a second application, the account logged in the second application being the same as an account logged in a first application; and
a display code configured to cause at least one of the at least one processor to acquire an operation instruction for the first application, execute the operation instruction in the first application, and display the multimedia resource.

17. The apparatus according to claim 16, wherein to acquire the multimedia resource, the acquisition code is further configured to cause the at least one of the at least one processor to:
acquire the historical data, the historical data comprising virtual objects acquired by the account logged in the second application and object information of the virtual objects;
determine, in response to the number of virtual objects acquired by the account being not less than a target number, a target object matching the account from the virtual objects acquired by the account based on the object information of the virtual objects acquired by the account; and
acquire the multimedia resource based on the target object.

18. The apparatus according to claim 17, wherein to determine the target object, the acquisition code is further configured to cause the at least one of the at least one processor to:
determine a weight parameter corresponding to the object information based on the object information of the virtual objects acquired by the account;
determine matching degrees between the virtual objects acquired by the account and the account based on the object information of the virtual objects acquired by the account and the weight parameter corresponding to the object information; and
take a virtual object with the highest matching degree among the virtual objects acquired by the account as the target object.

19. The apparatus according to claim 16, wherein the display processor configured to display the multimedia resource is further configured to:
display the multimedia resource by means of outward diffusion by taking an operation control displayed on a display interface of the first application as a reference point.

20. A non-transitory computer readable medium having stored thereon computer program code which, when executed by at least one processor, causes the at least one processor to at least:
acquire a multimedia resource that is determined based on historical data of an account logged in a second application, the account logged in the second application being the same as an account logged in a first application; and
acquire an operation instruction for the first application, executing the operation instruction in the first application, and displaying the multimedia resource.
